(19) United States
(12) Patent Application Publication
(10) Pub. No.: US 2009/0240591 A1
(43) Pub. Date: Sep. 24, 2009

(54) RESTAURANT MENU

(76) Inventors: Kevork Wartersian, West Bloomfield, MI (US); Galina Wartersian, West Bloomfield, MI (US)

Correspondence Address: Dickinson Wright PLLC, 38525 Woodward Avenue, Suite 2000, Bloomfield Hills, MI, 48304-5092, US

(21) Appl. No.: 12/053,562

(22) Filed: Mar. 22, 2008

(51) Int. Cl. G06Q 50/00

(52) U.S. Cl. 705/15

(57) ABSTRACT

A restaurant menu is provided comprising a plurality of menu selections, a plurality of corresponding prices each associated with one of said plurality of menu selections, and a plurality of selectively revealable messages each corresponding to one of said menu selections.

### TECHNICAL FIELD

The present invention relates generally to a restaurant menu and more particular to a restaurant menu with interactive selectively revealable messages.

### BACKGROUND OF THE INVENTION

Restaurant menus have a long and varied history. The variations in form, shape, and content have undergone uncountable iterations. Their primary function, however, is to present to customers the restaurant's food selections and convey the associated price of these food selections. Customers commonly make a choice of the food selections based on a combination of taste and price. In this fashion, the restaurant menu system fulfills a strictly utilitarian objective of communicating choices and cost. The Restaurant Menu, however, has the capacity to more intimately engage the consumer and to act as a promotion of the restaurant or for the restaurant owner.

It is known in the industry that restaurant promotion may be achieved through the use of games wherein the customer may win free or discounted food. The use of such gaming devices has been used to increase consumer awareness as well as draw restaurant attendance. These promotional materials, however, are typically given to consumers after a visit to the restaurant has concluded such that they act as a draw for an additional visit. It is conceived that a promotion that rewarded consumers during a present visit might appeal more to consumers as society has become addicted to instant gratification. In addition, it is contemplated that the same gaming style promotion may be utilized to entertain or educate consumers while they contemplate their order. As such, it would be highly beneficial to have a selectively revealable message incorporated directly into a restaurant menu system.

### SUMMARY OF THE INVENTION

In accordance with the objects of the present invention, a restaurant menu is provided comprising a plurality of menu selections, a plurality of corresponding prices each associated with one of said plurality of menu selections, and a plurality of selectively revealable messages each corresponding to one of said menu selections.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an embodiment of a restaurant menu in accordance with the present invention;

FIG. 2 is an illustration of the restaurant menu illustrated in FIG. 1, one of the selectively revealable messages illustrated revealed;

FIG. 3 is an illustration of a variety of selectively revealable messages for use in the restaurant menu illustrated in FIG. 1;

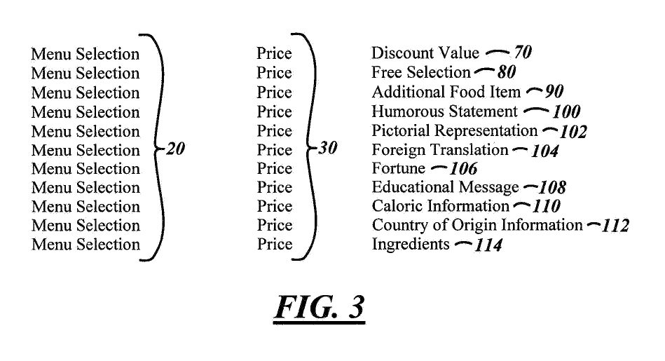

FIG. 4 is an alternate embodiment of a restaurant menu in accordance with the present invention.

### DESCRIPTION OF PREFERRED EMBODIMENTS

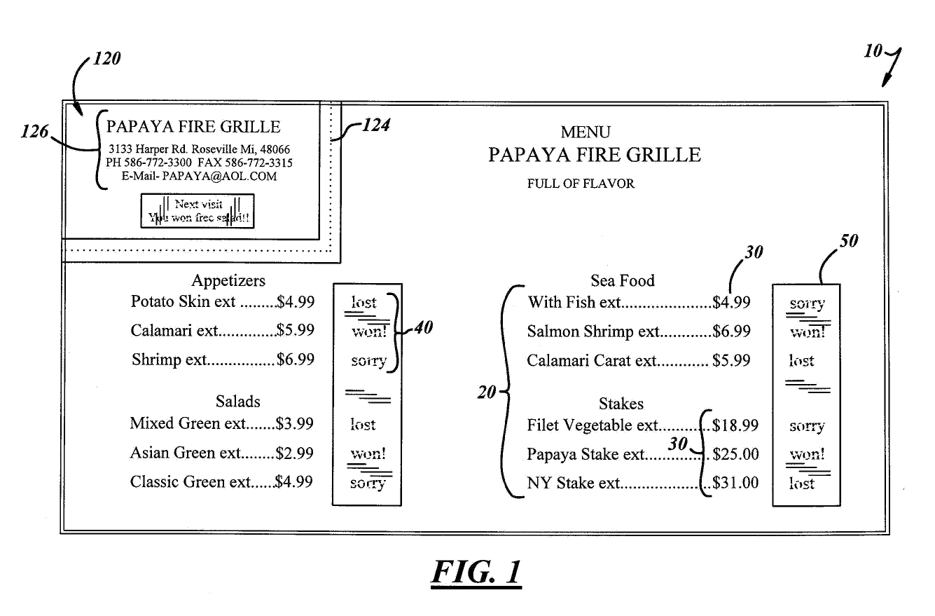

Referring to FIG. 1, which is an illustration of a restaurant menu 10 in accordance with the present invention. The restaurant menu 10 is illustrated as organized in a particular fashion. It should be understood, however, that a variety of designs and organizational concepts will become apparent in light of the present disclosure and are contemplated by the present invention.

The restaurant menu 10 includes a plurality of menu selections 20. Each of the menu selections 20 is intended to comprise any combination of food selections, drink selections, meal selections, appetizer selection, or any other restaurant based product. Associated with each of the plurality of menu selections 20 is a corresponding price 30 as is well understood in the restaurant industry. This is the present basis for restaurant menu ordering. The present invention, however, further includes a plurality of selectively revealable messages 40 each of which corresponds to one of the plurality of menu selections 20. It is contemplated that the plurality of selectively revealable messages 40 may be positioned immediately adjoining the corresponding menu selection 20 or corresponding price 30. It should be understood that the term selectively revealable is contemplated to encompass any hidden message that may be revealed only by way of an action of the consumer.

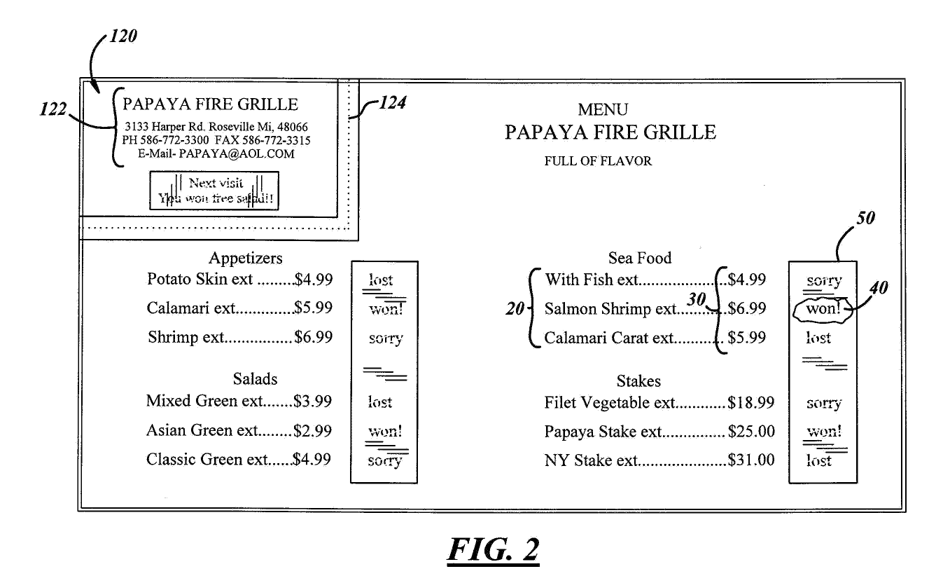

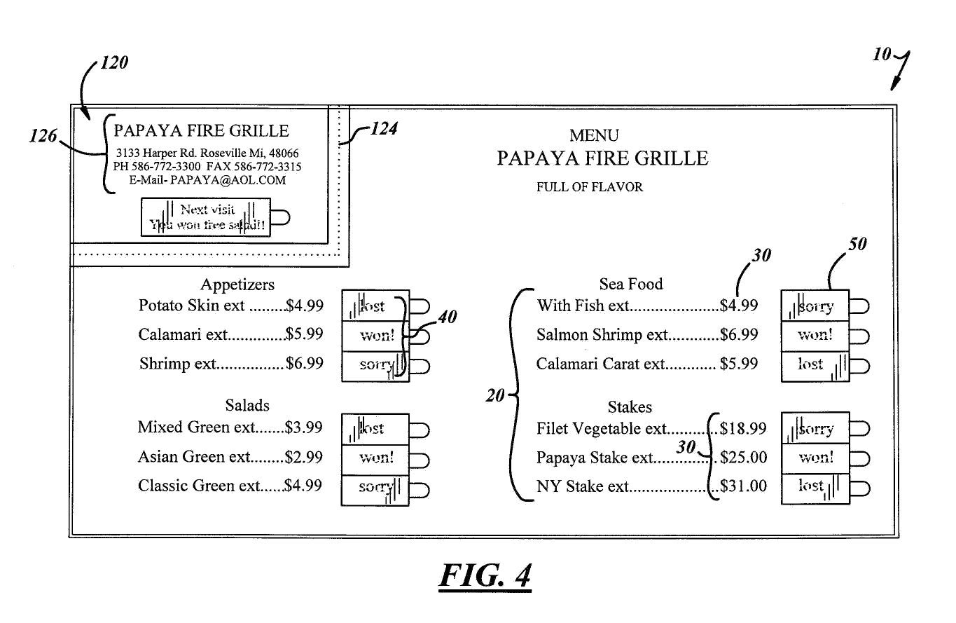

In one embodiment, the selectively revealable messages 40 are contemplated to be selectively revealable by way of a scratch-off coating region 50 covering the selectively revealable messages 40. In this fashion, a consumer may make a menu selection and then selectively scratch off the portion of the region 50 immediately adjacent the menu selection 20 or corresponding price 30 in order to selectively reveal the appropriate message 40 associated with that particular menu selection 20 (see FIG. 2). Although the selectively revealable messages 40 have been described in accordance with a scratch-off coating region 50, it should be understood that a variety of selectively revealable methodologies may be implemented in light of the present disclosure including, but not limited to, pull tab elements 60 as shown in FIG. 4.

It is contemplated that the selectively revealable messages 40 may encompass a wide variety of messages aimed at promoting, entertaining, or educating the consumer. In the simplest form, the selectively revealable messages 40 may be discount values ($1.00 off!) 70 or free selections (Free! or Try Again) 80 wherein the consumer reveals the message after making his menu selection. In this embodiment, cheating is easily avoided by voiding any discounts wherein multiple messages are revealed. The consumer makes his selection and immediately garners the value of the prize during the present visit rather than being required to re-visit the location and possibly lose track of the discount. Although discount values 70 and free selections 80 have been discussed, a variety of prize based rewards are contemplated including, but not limited to, additional food items 90.

The present invention further contemplates that the selectively revealable messages 40 may encompass non-prize related messages as well in order to entertain or educate the customers. In these non-prize related scenarios it is contemplated that the consumer may reveal more than one of such messages without negative consequences. As such humorous statements 100 may be revealed possibly casting humor relating to the selected food item. Pictorial representations 102 may be revealed thus allowing both children, non native language readers, or the illiterate to make intelligent selections. In the same vein, foreign translations 104 of the menu selections 20 may be revealed thus catering to a foreign speaking group or helping to educate native speaking audiences to foreign words for known food items. Fortunes 106 themselves may be particularly entertaining in restaurants such as American-Chinese cuisine. General educational messages 108 may be useful in school or museum cafeterias. Caloric information 110 may be highly beneficial if implemented in restaurants catering to healthy selections. Country of Origin 112 information may be beneficial to restaurants catering to multi-ethnic dishes. Ingredients 114 may be useful to those clients with allergies or taste preferences. It should be understood that although a variety of selectively revealable messages 40 have been described in detail, an even greater variety will become apparent in light of the present disclosure.

The present invention further contemplates the use of removable portion 120 preferably including portable restaurant information 122. This portable restaurant information 122 is contemplated to include address, contact information, possible menu selections, etc. Although a variety of examples are given, it is contemplated that the portable restaurant information 122 may incorporate a wide variety of information that may be easily taken by the customer from the restaurant without necessitating bringing the entire menu 10. As such it is preferably contemplated that the removable portion 120 comprise a perforated section 124 approximately business card size such that the customer may easily store the removable portion 120 in a wallet or purse. The removable portion 120 may also incorporate a secondary selectively revealable message 126 formed thereon. This secondary selectively revealable message 126 may include any of the aforementioned messages. It is preferably contemplated, however, that the secondary selectively revealable message 126 comprise a prize based message to promote customers revisiting the restaurant to redeem.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A restaurant menu comprising:
a plurality of menu selections;
a plurality of corresponding prices, each of said plurality of corresponding prices associated with one of said plurality of menu selections; and
a plurality of selectively revealable messages, each of said selectively revealable messages corresponding to one of said menu selections.

2. A restaurant menu as described in claim 1, wherein said plurality of selectively revealable messages comprise discount values.

3. A restaurant menu as described in claim 1, wherein said plurality of selectively revealable messages comprise free selections.

4. A restaurant menu as described in claim 1, wherein said plurality of selectively revealable messages comprise additional food items.

5. A restaurant menu as described in claim 1, wherein said plurality of selectively revealable messages comprise humorous statements.

6. A restaurant menu as described in claim 1, wherein said plurality of selectively revealable messages comprise pictorial representations of said plurality of menu selections.

7. A restaurant menu as described in claim 1, wherein said plurality of selectively revealable messages comprise foreign translations of said plurality of menu selections.

8. A restaurant menu as described in claim 1, wherein said plurality of selectively revealable messages comprise fortunes.

9. A restaurant menu as described in claim 1, wherein said plurality of selectively revealable messages comprise at least one scratch-off coating region covering said selectively revealable messages.

10. A restaurant menu as described in claim 9, wherein said plurality of selectively revealable messages comprises a plurality of scratch-off coating regions.

11. A restaurant menu as described in claim 1, wherein said plurality of selectively revealable messages comprise educational messages.

12. A restaurant menu as described in claim 1, further comprising:
a removable portion including portable restaurant information.

13. A restaurant menu as described in claim 12, wherein said removable portion comprises a perforated section approximately business card size.

14. A restaurant menu as described in claim 13, wherein said perforated section includes restaurant contact information.

15. A restaurant menu as described in claim 12, further comprising:
a secondary selectively revealable message positioned on said removable portion.

16. A restaurant menu comprising:
a plurality of menu selections;
a plurality of corresponding prices, each of said plurality of corresponding prices associated with one of said plurality of menu selections;
a plurality of selectively revealable messages, each of said selectively revealable messages corresponding to one of said menu selections; and
a removable portion including portable restaurant information.

17. A restaurant menu as described in claim 16, wherein said selectively revealable messages comprise caloric information relating to said plurality of menu selections.

18. A restaurant menu as described in claim 16, wherein said selectively revealable messages comprise country of origin information relating to said plurality of menu selections.

19. A restaurant menu as described in claim 16, further comprising:
a perforated section approximately business card size.

20. A restaurant menu as described in claim 19, wherein said perforated section includes restaurant contact information.

21. A restaurant menu as described in claim 16, wherein said plurality of selectively revealable messages comprise at least one scratch-off coating region covering said selectively revealable messages.

22. A restaurant menu as described in claim 16, further comprising:
a secondary selectively revealable message positioned on said removable portion.

23. A method of promoting a restaurant comprising:
incorporating a plurality of selectively revealable messages onto a restaurant menu having a plurality of menu selections and a corresponding plurality of menu prices;
giving said restaurant menu to consumers;
allowing the consumers to select one of said plurality of menu selections;
having the consumers then selectively reveal one of said plurality of selectively revealable messages corresponding to their selected menu selection; and
using said selectively revealable message to promote the restaurant.
